(19) United States
(12) Patent Application Publication
(10) Pub. No.: US 2022/0126392 A1
(43) Pub. Date: Apr. 28, 2022

(54) ULTRASONIC WELDING MOLD FOR MASK MACHINE CAPABLE OF QUICKLY CHANGING CUSTOMIZED PATTERNS

(71) Applicant: Health Pro Supplies Limited, Kowloon (HK)

(72) Inventor: Shum Hin LUNG, Kowloon (HK)

(21) Appl. No.: 17/078,916

(22) Filed: Oct. 23, 2020

(51) Int. Cl. B23K 20/10

(52) U.S. Cl. CPC B23K 20/10

(57) ABSTRACT

Disclosed is an ultrasonic welding mold for a mask machine capable of quickly changing customized patterns, including an ultrasonic welding wheel and a plurality of customized pattern components, wherein the customized pattern components are arranged on an outer surface of the ultrasonic welding wheel, and the customized pattern components are provided with printed patterns. Independent customized pattern components are arranged outside the ultrasonic welding wheel, so different customized pattern components can be replaced without removing other components, and the replacement is simple.

### FIELD OF THE INVENTION

The invention relates to an ultrasonic welding mold for a mask machine capable of quickly changing customized patterns.

### BACKGROUND OF THE INVENTION

An existing ultrasonic welding mold of an automatic flat mask machine adopts integral processing and molding (that is, customized patterns are integrally molded on ultrasonic welding wheels), so that when a manufacturer produces masks, the ultrasonic welding mold needs to be re-machined every time if LOGO or patterns need to be customized according to customer needs. This re-machining process requires a CNC and procedures of heat treatment, cylindrical grinding and the like, causing long time cycle and high cost for the manufacturer on customized needs of corresponding customers. In addition, the existing automatic flat mask equipment uses a mechanical synchronization device to ensure that an ultrasonic welding wheel, a flattening wheel, welding wheels on both sides, a cutter wheel, etc. are all in a synchronization state, the disassembly and assembly of this synchronization device break the synchronization state and need to readjust the equipment, and it takes a long time to change the mold and adjust the equipment, which wastes a lot of raw materials.

### SUMMARY OF THE INVENTION

According to one aspect of the invention, an ultrasonic welding mold for a mask machine capable of quickly changing customized patterns includes an ultrasonic welding wheel and a plurality of customized pattern components, the customized pattern components are arranged on an outer surface of the ultrasonic welding wheel, and the customized pattern components are provided with printed patterns. The independent customized pattern components are arranged outside the ultrasonic welding wheel, so different customized pattern components can be replaced without removing other components, and the replacement is simple.

In some implementation modes, the number of customized pattern components is two, the customized pattern components are semi-cylindrical, and the two semi-cylindrical customized pattern components are combined into a cylinder adapted to the outer diameter of the ultrasonic welding wheel and sleeved outside the ultrasonic welding wheel. Independent installation and removal can be realized, and the relative positions between the semi-cylindrical customized pattern components and the ultrasonic wheel can be adjusted to realize the position adjustment of customized patterns on masks.

In some implementation modes, the two semi-cylindrical customized pattern components are connected into a cylinder by set screws. The installation and removal are convenient and quick, and the replacement time is short.

In some implementation modes, outer surfaces of the customized pattern components are provided with printed patterns.

In some implementation modes, the number of customized pattern components is four, the customized pattern components are in the shape of arc plates, the outer surface of the ultrasonic welding wheel is provided with four grooves adapted to the customized pattern components, and the four customized pattern components in the shape of arc plates are respectively inlaid in the four grooves. Independent installation and removal can be realized, and one or more patterns can be printed on different positions of a mask.

In some implementation modes, the four customized pattern components in the shape of arc plates are fixed to the ultrasonic welding wheel by set screws. The installation and removal are convenient and quick, and the replacement time is short.

In some implementation modes, outer surfaces of the customized pattern components are provided with printed patterns.

### BRIEF DESCRIPTION OF THE DRAWINGS

FIG. 1 is a structural diagram of an ultrasonic welding mold for a mask machine capable of quickly changing customized patterns according to some implementation modes of the invention;

FIG. 2 is an exploded view of an ultrasonic welding mold for a mask machine capable of quickly changing customized patterns according to some implementation modes of the invention; and

FIG. 3 is an exploded view of an ultrasonic welding mold for a mask machine capable of quickly changing customized patterns according to some other implementation modes of the invention.

### DETAILED DESCRIPTION OF THE EMBODIMENTS

The invention will be further described in detail below with reference to the accompanying drawings.

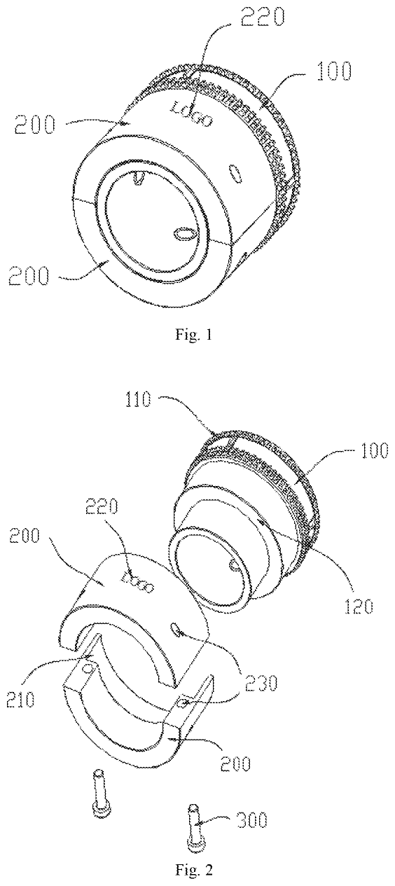

FIGS. 1-2 schematically show an ultrasonic welding mold for a mask machine capable of quickly changing customized patterns according to some implementation modes of the invention. As shown in the figures, the ultrasonic welding mold for the mask machine capable of quickly changing customized patterns according to this embodiment is suitable for an ultrasonic welding mold of a flat mask machine. An ultrasonic welding mold for a mask machine capable of quickly changing customized patterns includes: an ultrasonic welding wheel 100 and two customized pattern components 200.

In this embodiment, a welding block 110 is arranged on an outer surface of a first end of the ultrasonic welding wheel 100, and a second end is in the shape of a stepped boss 120.

In this embodiment, the two customized pattern components 200 are semi-cylindrical, and inner walls of the two semi-cylindrical customized pattern components 200 form stepped grooves 210 adapted to the stepped boss 120 at the second end of the ultrasonic welding wheel 100. The two semi-cylindrical customized pattern components 200 are combined into a cylinder adapted to the outer diameter of the ultrasonic welding wheel 100 and sleeved outside the second end of the ultrasonic welding wheel 100. Printed patterns 220 are formed on outer surfaces of the semi-cylindrical customized pattern components 200.

In this embodiment, side walls of the two semi-cylindrical customized pattern components 200 are provided with connecting screw holes 230, set screws 300 pass through the connecting screw holes 230 to connect the two semi-cylindrical customized pattern components 200 into a cylinder, and the set screws 300 may be hexagon socket head screws.

In some other implementation modes, the semi-cylindrical customized pattern components 200 are axially movable, and the customized pattern components 200 can be changed to adjust the relative positions with the ultrasonic welding wheel 100, thereby realizing the position adjustment of customized patterns on masks.

The two semi-cylindrical customized pattern components 200 are precisely machined to be adapted to the roundness and concentricity of the ultrasonic welding wheel 100. When the customized patterns are changed, other components do not need to be removed, so that the existing synchronization state of the equipment is not broken, and only the customized pattern components 200 are removed. At the same time, the customized patterns are installed on the basis of the ultrasonic welding wheel 100, instead of being installed on the same axis as the ultrasonic welding wheel 100, which can realize independent installation and removal. After the set screws 300 are loosened, the relative positions between the customized pattern components 200 and the ultrasonic welding wheel 100 can be adjusted, so as to realize the position adjustment of the customized patterns on the masks. The independent customized pattern components 200 can reduce the machining time of the mold and the machining cost of the mold. The customized pattern components 200 can be replaced at any time and their positions can be adjusted at any time, which reduces engineering time and raw materials required for equipment adjustment.

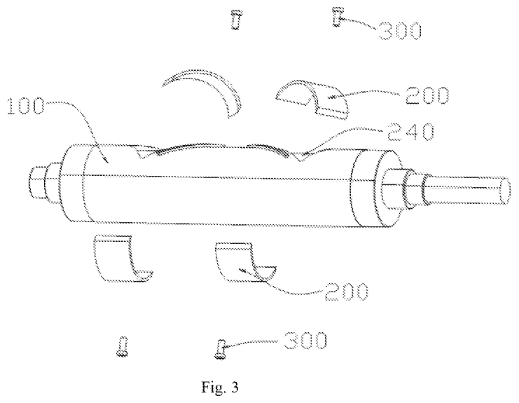

FIG. 3 schematically show an ultrasonic welding mold for a mask machine capable of quickly changing customized patterns according to some other implementation modes of the invention. As shown in the figure, the ultrasonic welding mold for the mask machine capable of quickly changing customized patterns according to this embodiment is suitable for an ultrasonic welding mold of an N95 mask machine. An ultrasonic welding mold for a mask machine capable of quickly changing customized patterns includes an ultrasonic welding wheel 100 and four customized pattern components 200.

In this embodiment, the four customized pattern components 200 are in the shape of arc plates, an outer surface of the ultrasonic welding wheel 100 is provided with four grooves 240 adapted to the customized pattern components 200, and the four customized pattern components in the shape of arc plates are respectively inlaid in the four grooves 240. Printed patterns 220 are formed on outer surfaces of the customized pattern components 200 in the shape of arc plates.

In this embodiment, the four customized pattern components 200 in the shape of arc plates are provided with screw holes in radial directions of the customized pattern components 200, the grooves 240 are provided with screw holes adapted to the screw holes, set screws 300 pass through the screw holes in the customized pattern components and the screw holes in the grooves 240 to fix the four customized pattern components 200 in the shape of arc plates with the ultrasonic welding wheel 100, and the set screws 300 may be hexagon socket head screws.

The four customized pattern components 200 are independently used as inlaid parts, and are precisely machined to be adapted to the roundness and concentricity of the ultrasonic welding wheel 100. When the customized pattern components 200 are changed, other components do not need to be removed, so that the existing synchronization state of the equipment is not broken, and only the customized pattern components 200 are removed. At the same time, the customized patterns are installed on the basis of the ultrasonic welding wheel 100, instead of being installed on the same axis as the ultrasonic welding wheel 100. After the customized patterns are used as inlaid parts, they can be installed and removed independently, so that the manufacturer can quickly install the customized patterns required by customers.

The above are only some implementation modes of the invention. Modifications and improvements may also be made by those of ordinary skill in the art without departing from the inventive concept of the invention, and these modifications and improvements shall all fall within the protection scope of the invention.

1. An ultrasonic welding mold for a mask machine capable of quickly changing customized patterns, comprising an ultrasonic welding wheel and a plurality of customized pattern components, wherein the customized pattern components are arranged on an outer surface of the ultrasonic welding wheel, and the customized pattern components are provided with printed patterns.

2. The ultrasonic welding mold for the mask machine capable of quickly changing customized patterns according to claim 1, wherein the number of customized pattern components is two, the customized pattern components are semi-cylindrical, and the two semi-cylindrical customized pattern components are combined into a cylinder adapted to the outer diameter of the ultrasonic welding wheel and sleeved outside the ultrasonic welding wheel.

3. The ultrasonic welding mold for the mask machine capable of quickly changing customized patterns according to claim 2, wherein the two semi-cylindrical customized pattern components are connected into a cylinder by set screws.

4. The ultrasonic welding mold for the mask machine capable of quickly changing customized patterns according to claim 3, wherein outer surfaces of the customized pattern components are provided with printed patterns.

5. The ultrasonic welding mold for the mask machine capable of quickly changing customized patterns according to claim 1, wherein the number of customized pattern components is four, the customized pattern components are in the shape of arc plates, the outer surface of the ultrasonic welding wheel is provided with four grooves adapted to the customized pattern components, and the four customized pattern components in the shape of arc plates are respectively inlaid in the four grooves.

6. The ultrasonic welding mold for the mask machine capable of quickly changing customized patterns according to claim 5, wherein the four customized pattern components in the shape of arc plates are fixed to the ultrasonic welding wheel by set screws.

7. The ultrasonic welding mold for the mask machine capable of quickly changing customized patterns according to claim 6, wherein outer surfaces the customized pattern components are provided with printed patterns.
